(19) United States
(12) Patent Application Publication
(10) Pub. No.: US 2011/0164041 A1
(43) Pub. Date: Jul. 7, 2011

(54) GRAPHIC INFORMATION PROCESSING DEVICE FOR FORMING AESTHETIC CURVES, GRAPHIC INFORMATION PROCESSING METHOD, AND GRAPHIC INFORMATION PROCESSING PROGRAM

(76) Inventor: Kenjiro Miura, Shizuoka (JP)

(21) Appl. No.: 12/996,242

(22) PCT Filed: Jun. 5, 2009
(86) PCT No.: PCT/JP2009/060365

§ 371 Date: Mar. 25, 2011

(30) Foreign Application Priority Data
Jun. 5, 2008 (JP) P2008-148495

(51) Int. Cl. G06T 11/20

(52) U.S. Cl. 345/442

(57) ABSTRACT

To easily form curves preferable for design (beautiful curves or aesthetic curves). A CAD system includes: a receiving unit that receives input of graphic information representing a line figure that includes a curve; a dividing unit that divides the line figure into a plurality of segments and generating a plurality of pieces of segment information corresponding to the plurality of segments; a first shaping unit that shapes a curve in each segment by converting each of the plurality of pieces of segment information through a function defined in terms of a curvature; a second shaping unit that further shapes the plurality of segments by converting each of the converted plurality of pieces of segment information so that a difference between a curvature at an endpoint of one segment represented by the piece of segment information and a curvature at an endpoint of another segment connected to the endpoint of the one segment becomes equal to or smaller than a predetermined threshold; and a display unit that outputs the graphic information representing the line figure that consists of the plurality of shaped segments.

### TECHNICAL FIELD

The present invention relates to a graphic information processing device, a graphic information processing method, and a graphic information processing program for forming or modifying line figures that include curves (forming aesthetic curves).

### BACKGROUND ART

Free curves are basic design elements in industrial product design, drawing, graphic design, font creation, or handwritten character input. Known techniques generally used for representing such free curves include Bezier curves and NURBS (Non-Uniform Rational B-Spline) curves (see Non Patent Literatures 1 and 2 below). These curves are polynomials with a scalar variable t as a parameter, or rational expressions in which the denominator or numerator is a polynomial. Studies of shaped curves (aesthetic curves) that can improve the design quality are also in progress (see a Non Patent Literature 3 below).

### Citation List

### Non Patent Literature

Non Patent Literature 1: Gerald Farin, Curves and Surfaces for CAGD, 5th Ed., Morgan Kaufmann (2002)
Non Patent Literature 2: Les Piegl, Wayne Tiller, The NURBS Book, 2nd Edition, Springer (1997)
Non Patent Literature 3: Kenjiro Miura, “A General Equation of Aesthetic Curves and Its Self-Affinity,” Journal of the Japan Society for Precision Engineering, Vol. 72, No. 7, pp. 857-861, 2006

### SUMMARY OF INVENTION

### Technical Problem

Bezier curves and NURBS curves do not explicitly control the curvature. Therefore, depending on the positional relationship among control points used to define a curve, the curvature (the radius of curvature which is an inverse of the curvature) may rapidly change, resulting in a shape of the curve unpreferable for design. For example, in input of a hand-drawn free curve, shakes of a hand are directly or indirectly reflected in the shape of the curve. This makes it difficult to input what is called an aesthetic curve as disclosed in the above Non Patent Literature 3.

The present invention has been made to solve the above inconvenience, and an object of the present invention is to provide a graphic information processing device, a graphic information processing method, and a graphic information processing program that allow easily forming curves preferable for design (beautiful curves or aesthetic curves).

### Solution to Problem

A graphic information processing device for forming aesthetic curves according to the present invention includes: receiving means for receiving input of graphic information representing a line figure that includes a curve; dividing means for dividing the line figure into a plurality of segments and generating a plurality of pieces of segment information corresponding to the plurality of segments; first shaping means for converting the plurality of pieces of segment information to generate an aesthetic curve by shaping a curve in each of the plurality of segments so that powers of a radius of curvature or a curvature of each segment are represented by a linear function of a curve length of the segment; second shaping means for shaping the plurality of segments by converting the plurality of pieces of segment information converted by the first shaping means so that a difference between a curvature at an endpoint of one segment and a curvature at an endpoint of another segment connected to the endpoint of the one segment becomes equal to or smaller than a predetermined threshold; and outputting means for outputting the graphic information about the line figure that consists of the plurality of segments shaped by the second shaping means.

A graphic information processing method for forming aesthetic curves according to the present invention includes: a receiving step of a graphic information processing device receiving input of graphic information representing a line figure that includes a curve; a dividing step of the graphic information processing device dividing the line figure into a plurality of segments and generating a plurality of pieces of segment information corresponding to the plurality of segments; a first shaping step of the graphic information processing device converting the plurality of pieces of segment information to generate an aesthetic curve by shaping a curve in each of the plurality of segments so that powers of a radius of curvature or a curvature of each segment are represented by a linear function of a curve length of the segment; a second shaping step of the graphic information processing device shaping the plurality of segments shaped in the first shaping step by converting the plurality of pieces of segment information converted in the first shaping step so that a difference between a curvature at an endpoint of one segment and a curvature at an endpoint of another segment connected to the endpoint of the one segment becomes equal to or smaller than a predetermined threshold; and an outputting step of the graphic information processing device outputting the graphic information about the line figure that consists of the plurality of segments shaped in the second shaping step.

A graphic information processing program for forming aesthetic curves according to the present invention causes a computer to perform: a receiving function for receiving input of graphic information representing a line figure that includes a curve; a dividing function for dividing the line figure into a plurality of segments and generating a plurality of pieces of segment information corresponding to the plurality of segments; a first shaping function for converting the plurality of pieces of segment information to generate an aesthetic curve by shaping a curve in each of the plurality of segments so that powers of a radius of curvature or a curvature of each segment are represented by a linear function of a curve length of the segment; a second shaping function for shaping the plurality of segments by converting the plurality of pieces of segment information converted by the first shaping function so that a difference between a curvature at an endpoint of one segment and a curvature at an endpoint of another segment connected to the endpoint of the one segment becomes equal to or smaller than a predetermined threshold; and an outputting function for outputting the graphic information about the line figure that consists of the plurality of segments shaped by the second shaping function.

In the graphic information processing device according to the present invention, the receiving means preferably receives input of point sequence data representing the line figure.

In the graphic information processing device according to the present invention, the first shaping means preferably shapes the curve so that powers of the radius of curvature or the curvature shifted by a predetermined amount are represented by a linear function of the curve length.

According to the above graphic information processing device, graphic information processing method, and graphic information processing program, first, a line figure is divided into a plurality of segments to generate a plurality of pieces of segment information. The segment information is then converted by shaping a curve in each segment so that powers of a radius of curvature or a curvature of each segment are represented by a linear function of a curve length of the segment. The segment information is then converted so that a difference in curvature at endpoints between two segments connected with each other becomes equal to or smaller than a predetermined threshold. This conversion is performed for each segment. The graphic information representing the line figure that consists of the segments shaped through the two conversions is output. Thus, the curvature that directly affects the impression of a curve is used to shape each segment, and the line figure is shaped to make curvatures at each joint between segments continuous. This allows easily forming a curve preferable for design.

A graphic information processing device for forming aesthetic curves according to the present invention includes: receiving means for receiving input of graphic information representing a line figure that includes a curve; dividing means for dividing the line figure into a plurality of segments and generating a plurality of pieces of segment information corresponding to the plurality of segments; first shaping means for generating an aesthetic curve by shaping each segment based on a curvature of the segment; second shaping means for shaping each segment shaped by the first shaping means based on a curvature at an endpoint of the segment; and outputting means for outputting the graphic information about the line figure that consists of the plurality of segments shaped by the second shaping means.

According to the above graphic information processing device, a line figure is divided into a plurality of segments, and a curve in each segment is shaped based on a curvature of the segment. Each segment is then shaped based on a curvature at an endpoint between each segment. The graphic information representing the line figure that consists of the plurality of segments shaped through the two conversions is output. Thus, the curvature that directly affects the impression of a curve is used to shape each segment, so that a curve preferable for design can be easily formed.

The graphic information processing device according to the present invention preferably further includes third shaping means for shaping the plurality of segments by converting the plurality of pieces of segment information converted by the second shaping means so that a difference between a derivative value of a curvature at an endpoint of one segment with respect to a curve length of the one segment and a derivative value of a curvature at an endpoint of another segment connected to the endpoint of the one segment with respect to a curve length of the another segment becomes equal to or smaller than a predetermined threshold, wherein the outputting means outputs the graphic information about the line figure that consists of the plurality of segments shaped by the third shaping means.

In this case, the segment information is converted so that, not only the difference between the curvatures but also the difference between the derivative values of the curvatures with respect to the curve lengths at endpoints of two segments connected with each other become equal to or smaller than a predetermined threshold. This conversion is performed for each segment. Then, the graphic information representing the line figure that consists of the segments shaped through the conversion is output. Thus, in addition to the continuity of curvatures between segments, the above-described continuity of derivative values is taken into account to shape each segment. This allows forming a curve more preferable for design.

In the graphic information processing device according to the present invention, the second shaping means preferably converts each of the plurality of pieces of segment information based on coordinates of an endpoint, a tangent direction at the endpoint, and a constant indicating the degree of bending of the curve in the segment in each of the plurality of segments. Thus, the segment information is converted based on the information affecting how the curve bends, so that a curve preferable for design can be formed.

In the graphic information processing device according to the present invention, the second shaping means preferably converts the plurality of pieces of segment information so that the tangent direction at the endpoint of each of the plurality of segments is changed while a position of the endpoint remains fixed. Generally, the position of an endpoint of a segment of a line figure is considered more important for design than the tangent direction at that point. Thus, the tangent direction at an endpoint of each segment is changed while keeping the position of the endpoint fixed, so that a curve preferable for design can be formed without significantly changing the impression of the line figure.

In the graphic information processing device according to the present invention, the dividing means preferably divides the line figure at an inflection point of the line figure. Thus, the figure is divided at a point where the curving direction changes, so that a curve more preferable for design can be formed.

### ADVANTAGEOUS EFFECTS OF INVENTION

According to the graphic information processing device, the graphic information processing method, and the graphic information processing program, the curvature is directly used to shape a line figure that includes a curve. Therefore, a curve preferable for design can be easily formed.

### BRIEF DESCRIPTION OF DRAWINGS

FIG. 1 is a diagram showing a functional configuration of a CAD system according to an embodiment.

FIG. 2 is a diagram showing an exemplary line figure that is input to the CAD system shown in FIG. 1.

FIG. 3 is a diagram showing an example of approximating the curve shown in FIG. 2 to a B-spline curve.

FIG. 4 is a diagram showing an example of dividing the B-spline curve shown in FIG. 3.

FIG. 5 is a diagram showing an example of shaping two aesthetic curve segments.

FIG. 6 is a diagram showing the relationship between the directional angle θ and the shape of an aesthetic curve.

FIG. 7 is a graph showing changes in curvature κ in FIG. 6.

FIG. 8 is a graph showing changes in constant α in FIG. 6.

FIG. 9 is a graph showing changes in curvature κ caused by conversion of segment information.

FIG. 10 is a diagram showing an example of shaping a line figure.

FIG. 11 is a graph showing a transition of the curvature κ corresponding to the line figure in FIG. 10.

FIG. 12 is a diagram showing an example of shaping the line figure shown in FIG. 2, where (a) shows the line figure before shaping and (b) shows the line figure after shaping.

FIG. 13 is a diagram showing changes in curvature κ corresponding to FIG. 12.

FIG. 14 is a flowchart showing a process in the CAD system shown in FIG. 1 where point sequence data is input.

FIG. 15 is a flowchart showing a process in the CAD system shown in FIG. 1 where control point data is input.

FIG. 16 is a diagram showing an example of shaping by the CAD system shown in FIG. 1.

FIG. 17 is a diagram showing a configuration of a graphic information processing program according to the embodiment.

### DESCRIPTION OF EMBODIMENTS

An embodiment of the present invention will be described in detail below with reference to the accompanying drawings, in which like or equivalent elements are given like symbols and will not be described repeatedly.

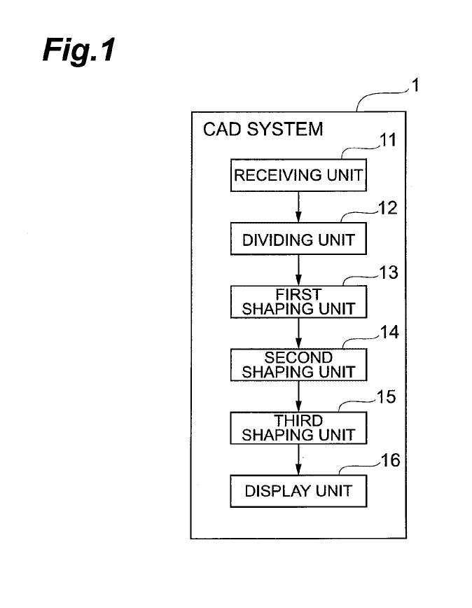

First, using FIGS. 1 to 13, description will be given of a configuration of a CAD (Computer Aided Design) system 1 to which a graphic information processing device according to the present invention is applied.

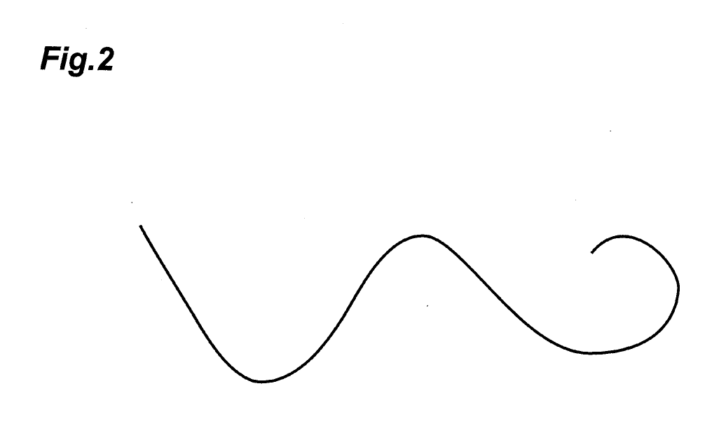

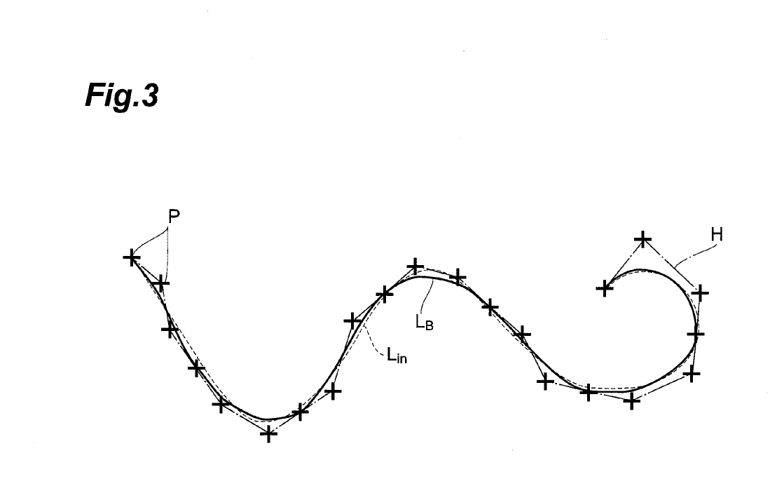

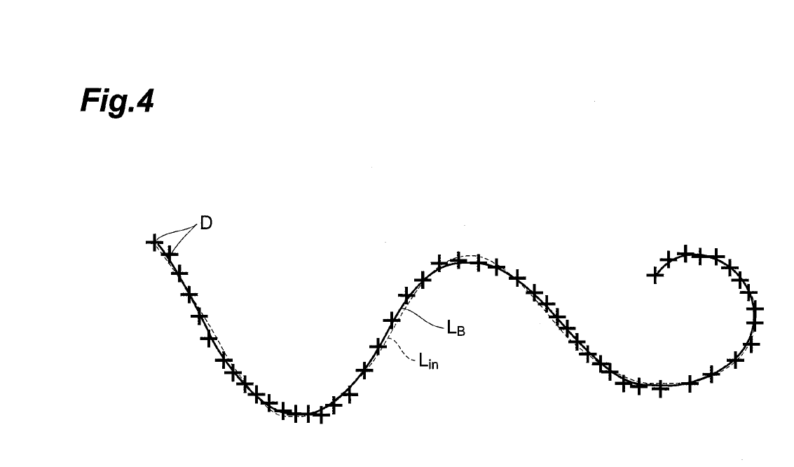

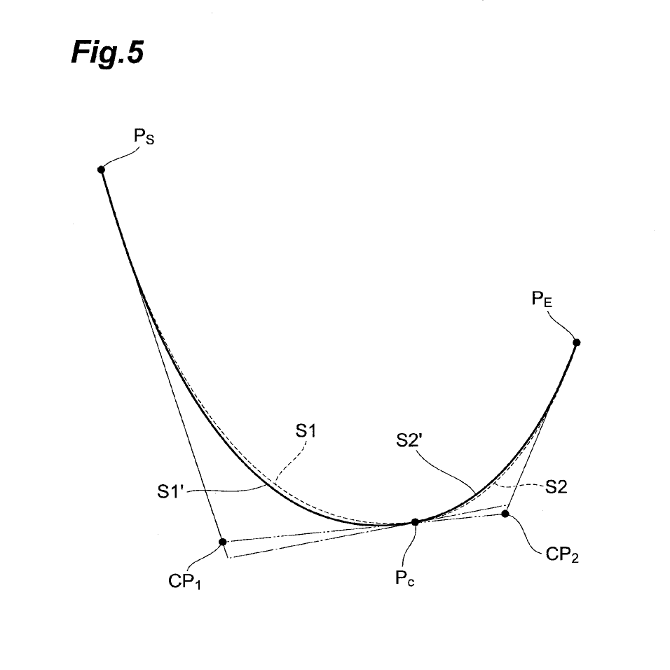

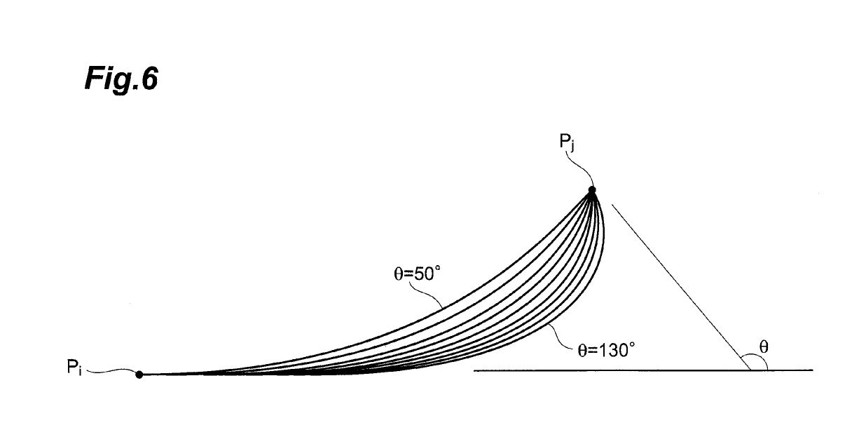

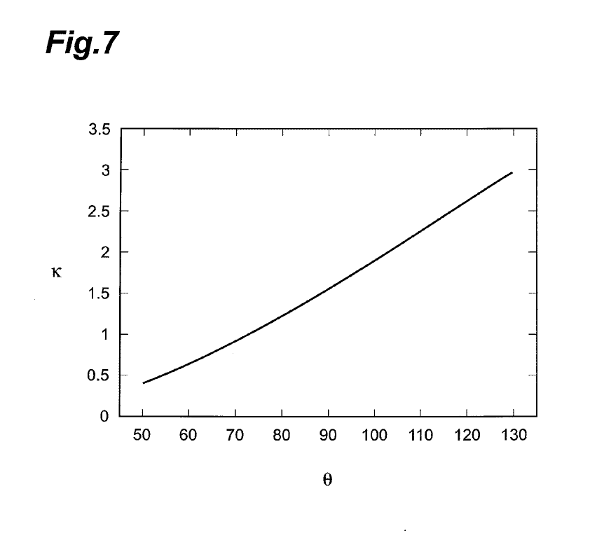

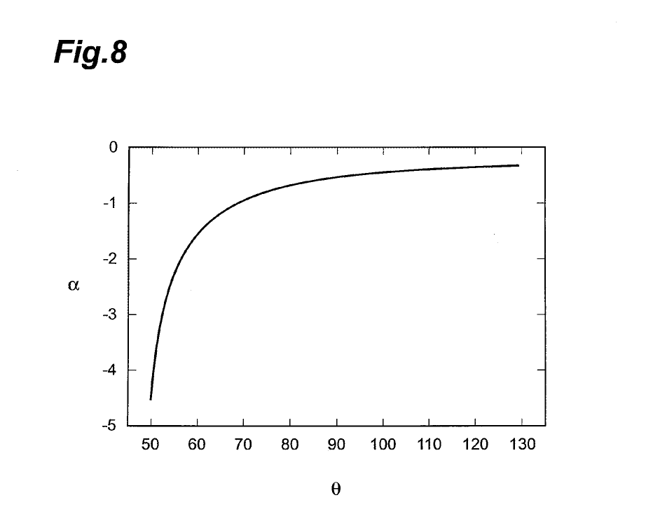

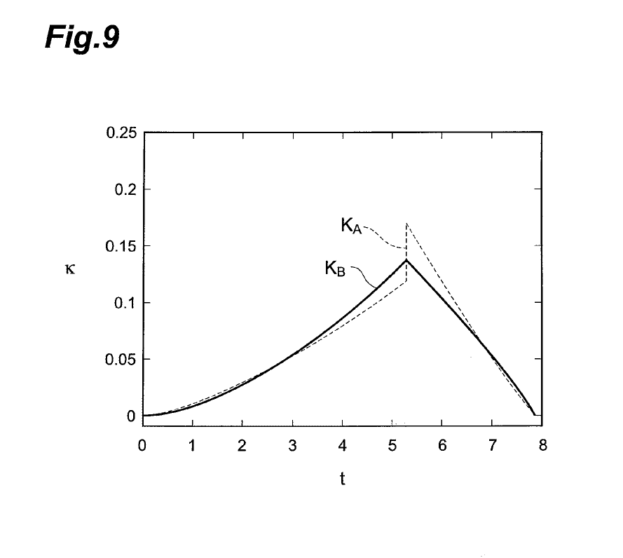

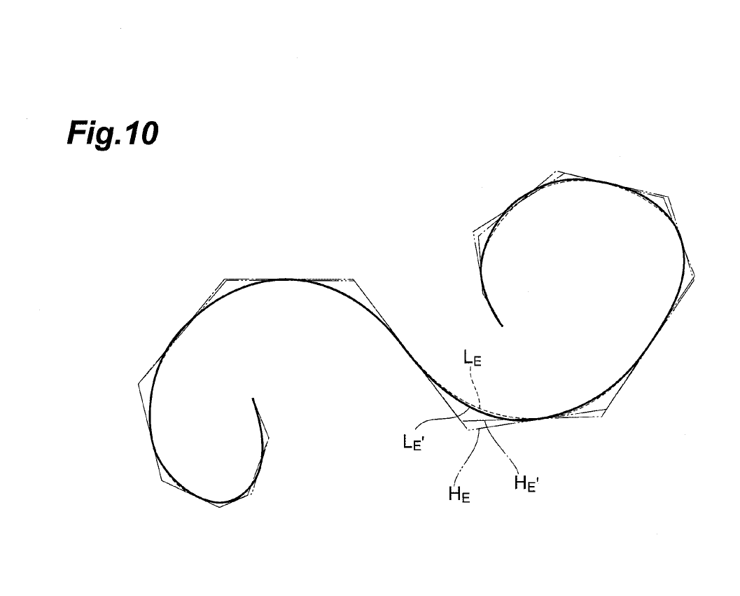

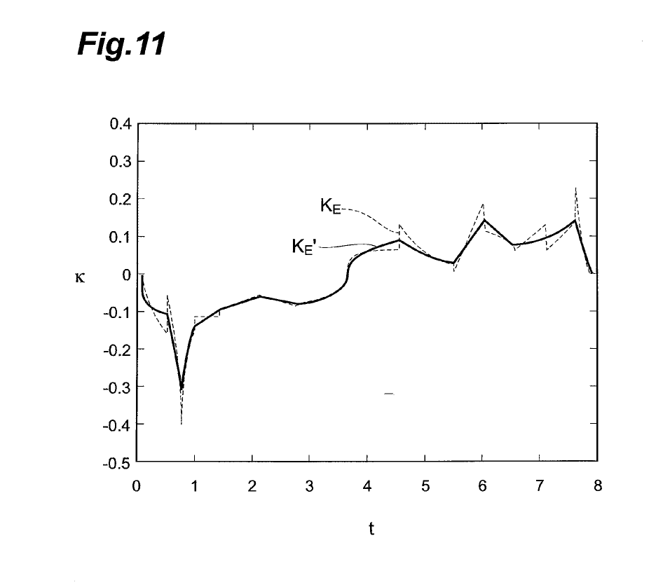

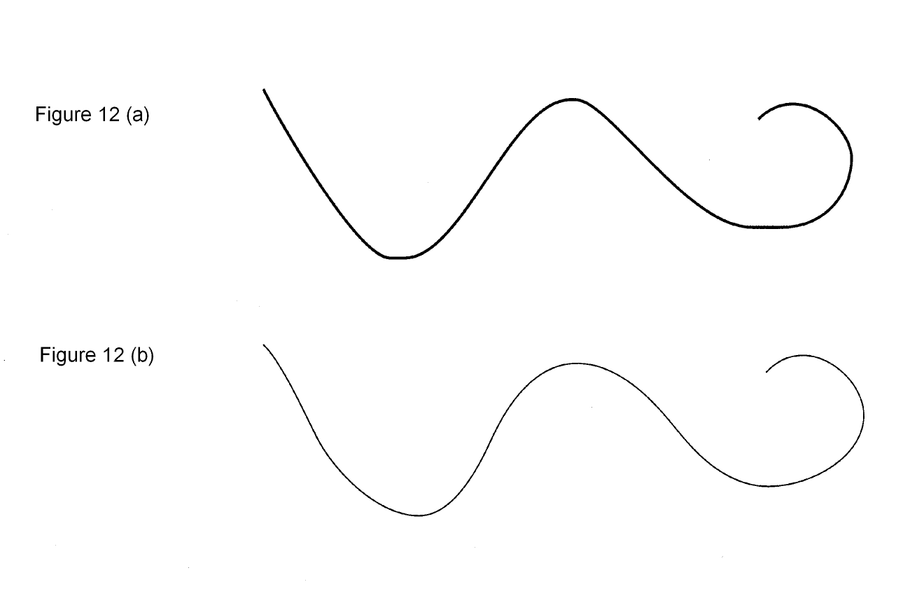

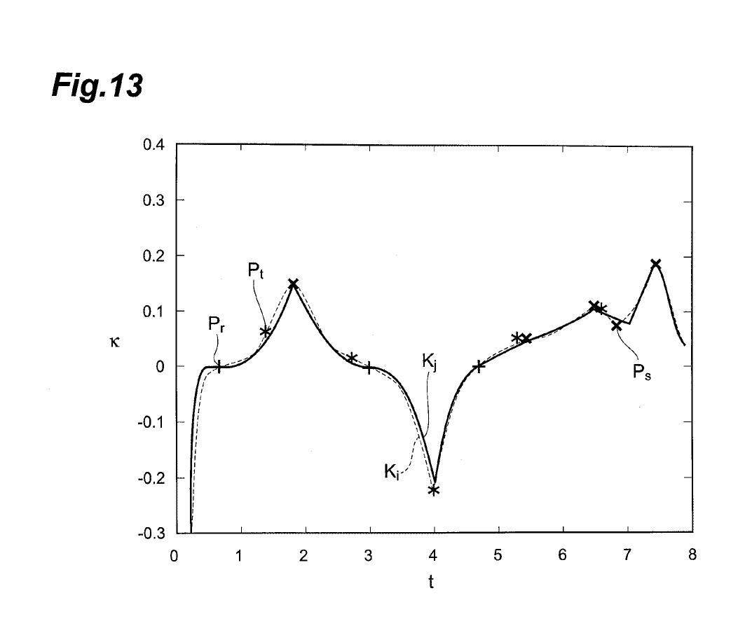

FIG. 1 is a diagram showing a functional configuration of the CAD system 1. FIG. 2 is a diagram showing an exemplary line figure that is input to the CAD system 1. FIG. 3 is a diagram showing an example of approximating the curve shown in FIG. 2 to a B-spline curve. FIG. 4 is a diagram showing an example of dividing the B-spline curve shown in FIG. 3. FIG. 5 is a diagram showing an example of shaping two aesthetic curve segments (to be described later). FIG. 6 is a diagram showing the relationship between the directional angle θ and the shape of an aesthetic curve. FIG. 7 is a graph showing changes in curvature κ in FIG. 6. FIG. 8 is a graph showing changes in constant α (to be described later) in FIG. 6. FIG. 9 is a graph showing changes in curvature κ caused by conversion of segment information. FIG. 10 is a diagram showing an example of shaping a line figure. FIG. 11 is a graph showing a transition of the curvature κ corresponding to the line figure in FIG. 10. FIG. 12 is a diagram showing an example of shaping the line figure shown in FIG. 2. FIG. 13 is a diagram showing changes in curvature κ corresponding to FIG. 12.

The CAD system 1 is a computer system that receives data defining graphics of a two-dimensional or three-dimensional model represented on a plane, shapes the graphics represented by the received data, and outputs the shaped graphics. In other words, the CAD system 1 is a computer system that forms curves preferable for design.

Before describing the configuration of the CAD system 1 in detail, a curve preferable for design formed by the CAD system 1 will be described.

A free curve is represented by a single segment (a shape that can be represented by a single expression that uses a parameter t) or a plurality of segments.

For a single segment, there is a constant α indicating the degree of bending of the curve within the segment (determining the impression of the curve). Defining the curve by representing the α-th power of the radius of curvature as a linear function of the curve length provides a curve preferable for design (a curve that people feel beautiful). Here, the slope of a straight line in a logarithmic distribution diagram of curvature for the single segment is represented as the above constant α.

The abscissa of the logarithmic distribution diagram of curvature indicates log ρ, and the ordinate indicates log(ds/d(log ρ))=log(ρds/dρ), where s is the curve length (arc length, path length) of the curve and ρ is the radius of curvature. Since the logarithmic distribution diagram of curvature is given as a straight line, the certain constant α exists and the following equation holds:

$$\begin{matrix}[ Expression 1 ] & \\ log ( ρ \frac{d s}{d ρ} ) = α log ρ + C & ( 1 )\end{matrix}$$

where C is a constant. The above equation (1) is referred to as a “basic equation of aesthetic curves.” The equation (1) is modified as follows.

$$\begin{matrix}[ Expression 2 ] & \\ \frac{1}{{ρ}^{α - 1}} \frac{d s}{d ρ} = {e}^{C} = {C}_{0} & ( 2 )\end{matrix}$$

Thus, a certain constant c₀ exists, and the following equation holds.

$$\begin{matrix}[ Expression 3 ] & \\ {ρ}^{α - 1} \frac{d ρ}{d s} = {c}_{0} & ( 3 )\end{matrix}$$

From the above equation (3), if α≠0, a first general equation of aesthetic curves (hereinafter simply referred to as a “first general equation”) is obtained:

[Expression 4]

ρ^{α}=c₀s+c₁ (4)

If α=0, a second general equation of aesthetic curves (hereinafter simply referred to as a “second general equation”) is obtained:

[Expression 5]

ρ=c₀e^{c}^{₁}^{s} (5)

Hereinafter, a curve according to the first or second general equation is referred to as an aesthetic curve.

In a case where a free curve is represented by using a plurality of segments each being an aesthetic curve, the free curve can be considered as a curve preferable for design if the free curve has the following characteristics:

1. tangents between segments are continuous (hereinafter referred to as “G¹ continuity”),

2. curvatures (radii of curvature) at endpoints are the same between segments (hereinafter referred to as “G² continuity”), and

3. derivative values of curvatures with respect to curve lengths are the same between segments (hereinafter referred to as “G³ continuity”).

The G² continuity assumes that the G¹ continuity is guaranteed, and the G³ continuity assumes that the G² continuity is guaranteed. Therefore, a curve with the G² continuity guaranteed can be considered as more preferable for design than a curve with only the G¹ continuity guaranteed, and much more preferable for design if the G³ continuity is further guaranteed.

Now, the configuration of the CAD system 1 will be described. The CAD system 1 includes, as functional components, a receiving unit (receiving means) 11, a dividing unit (dividing means) 12, a first shaping unit (first shaping means) 13, a second shaping unit (second shaping means) 14, a third shaping unit (third shaping means) 15, and a display unit (outputting means) 16.

The receiving unit 11 is means for receiving graphic information representing a line figure that includes a curve, where the graphic information is input through an input device implemented as a pen tablet having a stylus pen. The curve included in the line figure may be any curve, for example a free curve or a circular arc. By way of example, the receiving unit 11 receives graphic information representing a line figure as shown in FIG. 2. Exemplary formats of the graphic information include point sequence data representing a line figure to be shaped, and data about control points (hereinafter referred to as control point data) defining a line figure to be formed (a line figure in which a curve portion is an aesthetic curve). The input device may be of any type, so that the graphic information may be input through a keyboard or a mouse rather than a pen tablet.

The receiving unit 11 outputs the received graphic information to the dividing unit 12. It is to be understood that the receiving unit 11 may output the graphic information to a storage device not shown (for example, memory or a hard disk) to store the graphic information therein.

The dividing unit 12 is means for dividing the line figure represented by the graphic information received by the receiving unit 11 into a plurality of segments and generating a plurality of pieces of segment information corresponding to the plurality of segments. The dividing unit 12 passively acquires, from the receiving unit 11, the graphic information received by the receiving unit 11, or actively acquires the graphic information by reading out the graphic information from the storage device. The dividing unit 12 outputs the generated segment information to the first shaping unit 13.

Dividing the line figure where the acquired graphic information is point sequence data will be first described. In this case, the dividing unit 12 begins by using the least square method to approximate the input line figure (point sequence) to a B-spline curve, which is one of typical parametric curves.

The objective function R of the least square method is the square sum of the distances between the input points and their corresponding points on the B-spline curve. This square sum is obtained by the following equation:

$$\begin{matrix}[ Expression 6 ] & \\ R = {\sum }_{i = 0}^{m - 1} {\vert {C}_{b} ( {t}_{i} ) - {Q}_{i} \vert}^{2} & ( 6 )\end{matrix}$$

where m is the number of points in the input point sequence, C_{b}(t) is the B-spline curve to be generated, Qᵢ (i=0, . . . , m−1) is the coordinates of each point in the input point sequence, and tᵢ is a parameter value corresponding to each point in the point sequence. The parameter value tᵢ is the ratio of the sum of the distances to the point with respect to the total sum of the distances of the point sequence, depending on a parameter range (typically 0≦t≦1). Since the above equation (6) is a quadratic for control points of a B-spline curve, the least square method can be used to determine the coordinates of the B-spline control points.

There are three types of parameters for controlling the shape of the B-spline curve: the order of the B-spline curve, the number of segments, and constraints at endpoints of the B-spline curve.

The cubic order is employed as the order. This is because of the fact that the order that minimizes the strain energy of a curve passing through the point sequence represented by the input point sequence data is cubic.

To increase the degree of approximation (to reduce the size of the objective function R), the number of segments may be increased. However, excessively increasing the number of segments causes, for example, susceptibility to shakes of a hand during pen input, resulting in a wavy B-spline curve. Therefore, the approximation is performed by beginning with one segment and incrementing the number of segments by one until the objective function R becomes smaller than a predetermined threshold Rₜ. In this manner, the optimal number of segments is derived.

As the constraints at each endpoint, it is possible to specify the coordinates of the endpoint, the tangent vector at the endpoint, and a natural termination condition (setting the curvature at the endpoint to zero). These constraints can be satisfied by formulating these conditions and using Lagrange's method of undetermined multipliers.

By using the above approximation technique, the dividing unit 12 generates approximation data representing the B-spline curve from the input point sequence data. The dividing unit 12 then divides the B-spline curve represented by the approximation data into segments. A dividing algorithm used by the dividing unit 12 will be described in detail below.

While the curvature monotonically increase or decrease for an aesthetic curve, the curvature typically increase and decrease for a B-spline curve. Therefore, to shape the B-spline curve into an aesthetic curve, it is necessary to discriminate the sign of the curvature and divide the B-spline curve at points where the curvature has the extremum (local maximum or minimum) and at inflection points. Each segment of an n-th order B-spline curve is equivalent to one n-th order Bezier curve. The following description will be made specifically for a method of determining inflection points and extrema on a cubic Bezier curve.

First, the inflection points will be described. A cubic Bezier curve is assumed as C(t)=(x(t), y(t)) (0≦t≦1). Where the first and second derivatives of x(t) and y(t) with respect t are denoted as

\dot{x}(t),\dot{y}(t),\ddot{x}(t),ÿ(t) [Expression 7]

and where

f(t)=\dot{x}(t)²+\dot{y}(t)²,g(t)²=\dot{x}(t)ÿ(t)−\ddot{x}(t)\dot{y}(t) [Expression 8]

the curvature κ(t) taking a positive or negative sign into account is represented by the following equation.

$$κ ( t ) = \frac{g ( t )}{{f ( t )}^{\frac{3}{2}}} \qquad [ Expression 9 ]$$

If the curve is not degenerated, it can be assumed that f(t)≠0, and a parameter value providing a curvature of 0 can be obtained by solving g(t)=0. Since g(t) is a cubic of t, it can be analytically solved.

Next, the extremum will be described. The curvature extremum is obtained by determining a parameter value that satisfies dκ(t)/dt=0.

Since

$$\begin{matrix}\frac{d}{d t} {κ ( t )}^{2} = 2 κ ( t ) \frac{d}{d t} κ ( t ) \\ = \frac{d}{d t} \frac{{g ( t )}^{2}}{{f ( t )}^{3}} \\ = \frac{g ( t ) ( 2 \dot{g} ( t ) f ( t ) - 3 g ( t ) \dot{f} ( t ) )}{{f ( t )}^{4}} = 0\end{matrix} \qquad [ Expression 10 ]$$

and the curvature κ(t) being 0 means an inflection point, the following equation can be solved.

h(t)=2ġ(t)f(t)−3g(t)\dot{f}(t)=0 [Expression 11]

Since f(t) is of fourth order, h(t) is of sixth order. The dividing unit 12 derives the solution of this equation through numerical calculation. For example, the dividing unit 12 divides a range from 0 to 1 with equal intervals. If the signs of h(t) at the both ends of each of the resulting intervals are different, the initial value is set to the middle point of the interval and Newton's method is used to increase the accuracy.

The dividing unit 12 uses a program defining the above theory to divide the B-spline curve represented by the approximation data into segments, and generates, as segment information, coefficients defining the resulting segments (Bezier curves).

Next, the case where the acquired graphic information is control point data will be described. In this case, the dividing unit 12 generates a line figure that consists of a plurality of n-th Bezier curves (for example, cubic Bezier curves) based on the control point data. Then, as in the case where the graphic information is the point sequence data, the line figure is divided into segments by determining inflection points and the extrema on the line figure. At this point, for each segment, the dividing unit 12 generates, as segment information, a coefficient defining a Bezier curve representing that segment.

FIG. 3 shows an exemplary conversion from the B-spline curve to a set of cubic Bezier curves. In FIG. 3, a dashed line Lᵢₙ is a line figure represented by the input point sequence data, cross marks P are control points for generating the B-spline curve, a dashed-dotted line H is a set of lines connecting the control points P, and a solid line L_{B} is the B-spline curve. FIG. 4 shows an example of dividing the B-spline curve shown in FIG. 3. Cross marks D in FIG. 4 are dividing points on the B-spline curve L_{B}.

The first shaping unit 13 is means for shaping the curve in each segment by using a function defined in terms of the curvature to convert each of the pieces of segment information generated by the dividing unit 12. Shaping a curve in a segment means making the curve in the segment an aesthetic curve. In this specification, a segment that includes an aesthetic curve is defined as an aesthetic curve segment. Although the following description will be made for an aesthetic curve segment that satisfies the first general equation, the same discussion also applies to an aesthetic curve segment that satisfies the second general equation.

An aesthetic curve represented by the first general equation (the above equation (4)) is uniquely determined by specifying the coordinates of the start point of the segment, the tangent direction at the start point, and the total length s₁ of the segment. Therefore, the following seven parameters determine an aesthetic curve segment.

1. the coordinates (x, y) of the start point: the number of parameters=2

2. the tangent direction at the start point: the number of parameters=1

3. the constant indicating the degree of bending of the segment (curve) (the slope of the straight line in the logarithmic distribution diagram of curvature) a: the number of parameters=1

4. the integral constants c₀, c₁: the number of parameters=2

5. the total length s₁: the number of parameters=1

These seven parameters are controllable. The constant α, the integral constants c₀, c₁, and the total length s₁ determine the shape of the curve. Further, the coordinates (x, y) of the start point and the tangent direction at the start point are taken into account to determine the specific position of the curve with its shape determined. For example, if the coordinates of the start point and terminal point of the segment and the tangent direction at each of these endpoints are specified, the number of constraints is six. Therefore, the curvature (the shape of the curve) can be uniquely determined for an arbitrary constant α.

Here, description will be given of formulation of aesthetic curves where one of the endpoints of a segment is an inflection point. Details of formulation where neither of the endpoints is an inflection point are described in N. Yoshida and T. Saito, Interactive Aesthetic Curve Segments, The Visual Computer (Pacific Graphics), Vol. 22, No. 9-11, pp. 896-905, 2006, for example.

If the curve length is assumed to be finite, the necessary and sufficient condition for an aesthetic curve segment to have an inflection point is that the slope of the straight line in the logarithmic distribution diagram of curvature α<0. The following description assumes that α<0. Assuming that s (>0) is the curve length in a complex plane, the first general equation of aesthetic curves is modified as

$$\begin{matrix}[ Expression 12 ] & \\ C ( s ) = {P}_{0} + {\int }_{0}^{S} {e}^{i b} {e}^{i {at}^{\frac{α - 1}{α}}} d t & ( 7 )\end{matrix}$$

where P₀ is the start point of the segment, a and b are constants, and e^{ib} is the tangent direction at the start point. As a standard form of the above equation (7), consider a curve such that a is limited as a>0, the start point is located at the origin, and the tangent at the origin is oriented in the positive direction of the real axis. Since the curve is similar even if the constant a is changed, it is assumed that a=1 and the above equation (7) becomes as follows.

$$\begin{matrix}[ Expression 13 ] & \\ C ( s ) = {\int }_{0}^{S} {e}^{i {t}^{\frac{α - 1}{α}}} d t & ( 8 )\end{matrix}$$

The directional angle θ of the curve represented by the above equation (8) is

$$\begin{matrix}[ Expression 14 ] & \\ θ = {s}^{\frac{α - 1}{α}} & ( 9 )\end{matrix}$$

and the curvature κ of the curve is

$$\begin{matrix}[ Expression 15 ] & \\ κ = \vert \frac{{d}^{2} C ( s )}{d {s}^{2}} \vert = \frac{α - 1}{α} {s}^{- \frac{1}{α}} & ( 10 )\end{matrix}$$

Therefore, for an arbitrary negative value α, if s=0, then κ=0. Accordingly, the start point is an inflection point. The curve length s and the directional angle θ are represented as functions of the curvature κ as follows, respectively.

$$s = \frac{{( α - 1 )}^{a}}{{α}^{α}} {κ}^{- α} , θ = \frac{{( α - 1 )}^{α - 1}}{{α}^{α - 1}} {κ}^{1 - α} \qquad [ Expression 16 ]$$

The curvature κ is represented in terms of the directional angle θ as follows.

$$κ = \frac{α - 1}{α} {θ}^{\frac{1}{1 - α}} \qquad [ Expression 17 ]$$

Considering guaranteeing the G² continuity and the G³ continuity of the line figure that consists of the aesthetic curve segments, having one endpoint of an aesthetic curve segment as an inflection point is equivalent to specifying the curvature at that endpoint as zero, which means that one constraint is added. Therefore, for example, if the coordinates of the start point and terminal point of a segment and the tangent direction at each of these endpoints are specified and further the curvature at the start point is set to zero, the number of constraints is seven. This matches the number of parameters of the first general equation that includes the constant α. Therefore, the curvature (the shape of the curve) is uniquely determined.

Details of generating the aesthetic curve segments based on this theory is as follows. For each of the input pieces of segment information (coefficients defining the Bezier curves), the first shaping unit 13 computes tangents at the both endpoints of the segment represented by that segment information, and then computes the intersection of the two tangents. The first shaping unit 13 then discretely computes points on the logarithmic distribution diagram of curvature from the Bezier curve and uses the least square method to compute the slope α of a straight line approximating the points. At this point, the first shaping unit 13 may compute the optimal constant α through a numerical solution that does not use derivation.

The first shaping unit 13 then uses the computed α, information about the both endpoints, information about the intersection, and the above equations (4) and (7) to (10) to generate an aesthetic curve segment in which the positions of the both ends and the tangent directions at the both endpoints match the original Bezier curve. The equation (4) is a function defined in terms of the curvature. From the equation (4), it can be seen that powers of the radius of curvature of the segment are represented by a linear function of the curve length of the segment. The equations (7) to (10) are functions deriving from the equation (4). Thus, the input segment information is converted by a program defining the equations (4) and (7) to (10) to generate segment information representing an aesthetic curve segment (information including the coordinates of the start point, the tangent direction at the start point, the constant α, the curve length s, the curvature κ, and the directional angle θ). Here, the directional angle θ is derived from the equation (9), and the curvature κ is derived from the equation (10).

The first shaping unit 13 generates an aesthetic curve segment for each segment in this manner. Thus, the tangent at the joint between aesthetic curve segments connected with each other becomes continuous, but the curvature at the joint is discontinuous.

The second shaping unit 14 is means for shaping the aesthetic curve segments shaped by the first shaping unit 13: this is done by converting each piece of segment information converted by the first shaping unit 13 so that the difference between the curvature at an endpoint of one segment (an aesthetic curve segment) represented by that piece of segment information and the curvature at an endpoint of another segment (an aesthetic curve segment) connected to the endpoint of the one segment becomes equal to or smaller than a predetermined threshold. That is, the second shaping unit 14 is means for guaranteeing the G² continuity between aesthetic segments. The second shaping unit 14 outputs the converted segment information to the third shaping unit 15.

The number of parameters in connecting two aesthetic curve segments while guaranteeing the G² continuity is 14, which is the sum of the number of parameters for each segment. On the other hand, the number of constraints is ten as follows.

1. the coordinates of the start point of a first segment, and the tangent direction at the start point: the number of constraints=3

2. the coordinates of the terminal point of a second segment, and the tangent direction at the terminal point: the number of constraints=3

3. at the joint between the first segment and the second segment, an endpoint (an endpoint that is not the start point) of the first segment and an endpoint (an endpoint that is not the terminal point) of the second segment are the same in position, tangent direction, and curvature: the number of constraints=4

Further, two constraints are added by allowing the constant α to be specified for the first and second segments.

Therefore, the number of constraints is 12 while the number of parameters is 14, so that two more constraints need to be added. For example, two constraints can be added by specifying the coordinates of the joint or by designating a specific tangent direction while limiting the joint on a certain line.

The number of parameters in connecting more than two aesthetic curve segments while guaranteeing the G² continuity is 7n, which is the sum of the number of parameters for n segments. On the other hand, the number of constraints is as follows.

1. the coordinates of the start point of a first segment, and the tangent direction at the start point: the number of constraints=3

2. the coordinates of the terminal point of an n-th segment, and the tangent direction at the terminal point: the number of constraints=3

3. at the joint between an i-th segment and an i+1-th segment, an endpoint of the i-th segment and an endpoint of the i+1-th segment are the same in position, tangent direction, and curvature: the number of constraints=4(n−1)

In addition, if the constant α for each segment (the number of constraints=n) and the coordinates of each joint (the number of constraints=2(n−1)) are specified, the number of constraints is 3+3+4(n−1)+n+2(n−1)=7n. Thus, the shape of the curve can be uniquely defined.

Deformation for making the curvatures between two aesthetic curve segments continuous will be described. If the endpoints are not inflection points, the curving direction of the curve (left-turning or right-turning) does not change, and the curvature monotonically increase or decrease within a single segment. Therefore, the curvatures at the both endpoints of the line figure that consists of the two aesthetic curve segments have the same sign. If the positions (coordinates) of the both endpoints and the tangent direction at each endpoint are specified, the curve can be defined by using ordered three points as control points, as in the case of defining a quadratic Bezier curve.

In this case, the magnitude of the curvature at the both endpoints of the line figure depends on the distance between the control points. That is, for an arbitrary constant α, if a distance d₁ between a first control point and a second control point is larger than a distance d₂ between the second control point and a third control point, the curvature on the terminal point side is larger (the radius of curvature is smaller), whereas if the distance d₁ is smaller than the distance d₂, the curvature on the start point side is larger (the radius of curvature is smaller). If the distance d₁ is equal to the distance d₂, the line figure that consists of the two aesthetic curve segments is a circular arc.

FIG. 5 is a diagram showing a line figure that consists of two aesthetic curve segments S1 and S2 indicated by dashed lines. The start point P_{S} and the terminal point P_{E} of the line figure are inflection points.

All parameters including the constant α are used for generating the aesthetic curve segments. Therefore, to make the curvature between the two aesthetic curve segments S1 and S2 continuous, the positions of control points CP₁ and CP₂ of the respective aesthetic curve segments S1 and S2 need to be changed. The following two methods are possible to maintain the original shape as much as possible:

1. move the joint P_{C} at which the two segments are connected (the endpoint common to the two segments) (in this case, the number of changeable parameters is two), and

2. change the tangent direction at the joint P_{C} while keeping the position of the joint P_{C} fixed (in this case, the number of changeable parameters is one).

Since the position of the joint P_{C} is generally considered more important for design than the tangent direction at the joint P_{C}, it can be said that changing the tangent direction is more preferable than moving the joint P_{C}. Therefore, in this embodiment, description will be made of a technique of changing the tangent direction at the joint P_{C} while keeping the position of the joint P_{C} fixed.

For a left-turning (right-turning) aesthetic curve segment with one of its endpoints being an inflection point, the curvature at the endpoint monotonically increases (decreases) with respect to the directional angle θ. FIG. 6 shows a set of aesthetic curve segments generated by varying the directional angle θ from 50 to 130° where one endpoint Pᵢ as an inflection point is located at the coordinates (0, 0) and the other endpoint Pⱼ is located at the coordinates (√2+1, 1). FIG. 7 is a graph showing a transition of the curvature κ for the directional angle θ, where the abscissa indicates the directional angle θ and the ordinate indicates the curvature κ. FIG. 8 is a graph showing a transition of the constant α for the directional angle θ, where the abscissa indicates the directional angle θ and the ordinate indicates the constant α. As shown in FIGS. 6 to 8, both of the curvature κ and the constant α increase with the increase of the directional angle θ.

If the relationships among the three variables θ, κ, and α are qualitatively maintained, it is possible to increase the curvature of the aesthetic curve segment S1 and decrease the curvature of the aesthetic curve segment S2 by rotating the directional angle counterclockwise around the joint P_{C} as in FIG. 5, because the curvature of the aesthetic curve segment S1 shown in FIG. 5 is relatively smaller than the curvature of the aesthetic curve segment S2 (see a dashed line K_{A} in FIG. 9). Thus, these curvatures can be matched each other fast through the bisection method (see a solid line K_{B} in FIG. 9). Here, the aesthetic curve segments S1 and S2 are shaped as indicated by solid lines S1′ and S2′ in FIG. 5.

For a line figure that consists of two aesthetic curve segments each having one endpoint as an inflection point, the curvature at the endpoint is fixed to zero. Therefore, even if the inflection point connects to another aesthetic curve segment, the change in the curvature due to the deformation is limited within the two segments and does not affect the continuity of the curvature. However, if the endpoint is not an inflection point, the deformation for guaranteeing the continuity of the curvature at one endpoint causes the magnitude of the curvature at another endpoint to be changed, compromising the continuity of the curvature at the other endpoint.

Therefore, it is desirable to use a numerical optimization technique such that directional angles between segments are variables, the objective function is the difference between the curvatures of the segments squared, and derivatives of the objective function are not required like Powell's method. However, numerical optimization techniques generally involve slow processing, and further the processing speed is significantly reduced if derivatives of the objective function are not available. Therefore, a technique is used in which the approach of rotating the aesthetic curve segments connected with each other at the joint (see FIG. 5) is sequentially applied between segments having the largest curvature difference and finishes the conversion of the aesthetic curve segments once the curvature differences between all segments have converged to values equal to or smaller than a predetermined threshold. The second shaping unit 14 converts the input segment information according to a program defining the above conversion processing and outputs the converted segment information to the third shaping unit 15.

FIG. 10 shows an example of shaping a line figure according to this technique. In FIG. 10, a line figure L_{E} and an auxiliary line H_{E} connecting control points of the line figure L_{E} show the state before shaping, and a line figure L_{E}′ and an auxiliary line H_{E}′ connecting control points of the line figure L_{E}′ show the state after shaping. Here, as shown in FIG. 11, a curvature distribution K_{E} of the line figure L_{E} changes as indicated by a solid line K_{E}′. This means that the curvatures are continuous between all aesthetic curve segments and the G² continuity is guaranteed. The ordinate and abscissa of the graph in FIG. 11 indicate the curvature κ and the parameter t, respectively.

FIG. 12(a) shows a line figure similar to the line figure shown in FIG. 2, and FIG. 12(b) shows a shaped line figure resulting from shaping each segment of the line figure in FIG. 12(a) into an aesthetic curve and further guaranteeing the G² continuity. FIG. 13 shows the curvature, inflection points, and curvature extrema of the B-spline curve generated based on the line figure shown in FIG. 12(a), and the curvature of the shaped line figure shown in FIG. 12(b). The ordinate and abscissa of the graph in FIG. 13 indicate the curvature κ and the parameter t, respectively. In FIG. 13, a solid line Kᵢ represents the curvature of the aesthetic curve, and a dashed line Kⱼ represents the curvature of the B-spline curve. Points indicated by a cross mark Pᵣ are inflection points, points Pₛ indicated by a mark × are points where the curvature has the extremum, and points Pₜ indicated by a mark * are endpoints of the B-spline segment. The curvature around the endpoints Pᵣ and Pₛ gently changes for the B-spline curve, whereas the curvature around the endpoints Pᵣ and Pₛ instantaneously changes for the aesthetic curve.

The third shaping unit 15 is means for shaping the segments shaped by the second shaping unit 14: this is done by converting each piece of segment information converted by the second shaping unit 14 so that the difference between the derivative value of the curvature at an endpoint of one segment represented by that piece of segment information with respect to the curve length of the one segment and the derivative value of the curvature at an endpoint of another segment connected to the endpoint of the one segment with respect to the curve length of the other segment becomes equal to or smaller than a predetermined threshold. That is, the third shaping unit 15 is means for guaranteeing the G³ continuity between aesthetic segments. The third shaping unit 15 outputs the converted segment information (segment information that constitutes the line figure satisfying the G³ continuity) to the display unit 16.

If the G³ continuity can be guaranteed, a compound rhythm curve can be generated by specifying constants α with different signs for two adjacent segments. A compound rhythm curve refers to a curve that consists of segments each having a different constant α and that has the G³ continuity guaranteed.

The number of parameters where the G³ continuity between two aesthetic curve segments is guaranteed is 14, which is the sum of the number of parameters for the two segments. On the other hand, the number of constraints is 11 as follows.

1. the coordinates of the start point of a first segment, and the tangent direction at the start point: the number of constraints=3

2. the coordinates of the terminal point of a second segment, and the tangent direction at the terminal point: the number of constraints=3

3. an endpoint (an endpoint that is not the start point) of the first segment and an endpoint (an endpoint that is not the terminal point) of the second segment connected with each other are the same in coordinates, tangent direction, curvature, and derivative value of the curvature: the number of constraints=5

Further, two constraints are added by allowing the constant α to be specified for each of the first and second segments. Therefore, the number of constraints is 13 while the number of parameters is 14, so that one more constraint needs to be added. For this purpose, for example, the tangent direction at the joint may be specifically designated.

By way of example, consider generating a compound rhythm curve with four control points. First, the coordinates and the tangent directions at the both endpoints are specified with the four control points. In addition, the direction from the second control point to the third control point is specified as the tangent direction at the joint. Now the number of parameters matches the number of constraints, so that the shape of the curve can be uniquely determined.

The number of parameters in connecting n aesthetic curve segments (n≧3) while guaranteeing the G³ continuity is 7n, which is the sum of the number of parameters for n segments. On the other hand, the number of constraints is as follows.

1. the coordinates of the start point of a first segment, and the tangent direction at the start point: the number of constraints=3

2. the coordinates of the terminal point of an n-th segment, and the tangent direction at the terminal point: the number of constraints=3

3. an endpoint of an i-th segment and an endpoint of an i+1-th segment connected with each other are the same in coordinates, tangent direction, curvature, and derivative value of the curvature: the number of constraints=5(n−1)

In addition, if the constant α for each segment (the number of constraints=n) and the tangent direction at each joint (the number of constraints=n−1) are specified, the number of constraints is 3+3+5(n−1)+n+(n−1)=7n. Therefore, the shape of the curve can be uniquely determined. For example, as four control points are used for specifying two segments, n+2 control points may be used for specifying n segments. The n+2 control points may be set as control points of the Bezier curves or cubic B-spline curve to determine the tangent directions at the joints.

When matching the derivative values of the curvatures between the segments, the third shaping unit 15 can use an approach of finishing the conversion of the segment information once the differences in derivative values of the curvatures between all segments have converged to values equal to or smaller than a predetermined threshold.

The display unit 16 is means for outputting the graphic information representing the line figure that consists of the segments shaped by the third shaping unit 15 to a monitor, a printer, or the like. Specifically, the display unit 16 generates point sequence data representing the shaped line figure based on the pieces of segment information (the coordinates of the start point of each segment, the tangent direction at the start point, the curve length of the segment, the curvature, and the directional angle) input from the third shaping unit 15. Thus, a user of the CAD system 1 can visually recognize the shaped line figure (a line figure that consists of aesthetic curve segments).

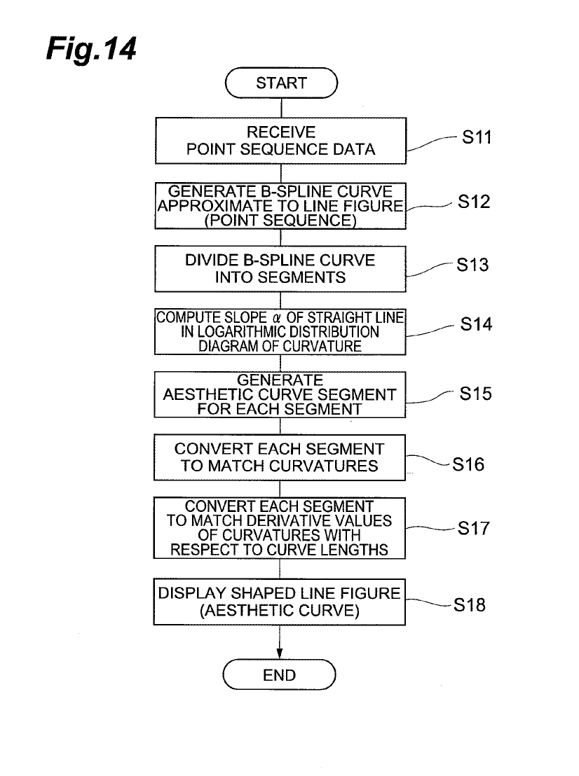

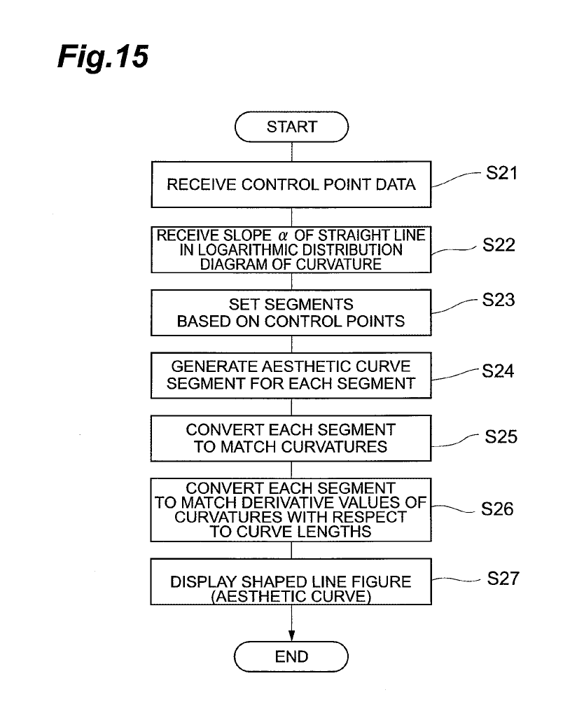

Now, by using FIGS. 14 and 15, processes in the CAD system 1 shown in FIG. 1 will be described, and the graphic information processing method according to this embodiment will be described. FIG. 14 is a flowchart showing a process where point sequence data is input, and FIG. 15 is a flowchart showing a process where control point data is input.

First, with reference to FIG. 14, the process where point sequence data representing a line figure is input will be described. In this case, the receiving unit 11 receives point sequence data (step S11, a receiving step). The dividing unit 12 then generates a B-spline curve approximate to a line figure represented by the point sequence data (step S12) and divides the B-spline curve into segments (step S13, a dividing step). The first shaping unit 13 then computes the slope α of the straight line in the logarithmic distribution diagram of curvature (step S14) and generates an aesthetic curve segment for each segment based on the computed α (step S15, a first shaping step).

The second shaping unit 14 then converts each segment so that the difference in curvature between two endpoints at the joint of adjacent aesthetic curve segments becomes equal to or smaller than a predetermined threshold (preferably, the two curvatures become equal) (step S16, a second shaping step). This guarantees the G² continuity between the aesthetic curve segments.

The third shaping unit 15 then converts each segment so that the derivative values of the curvatures of two endpoints at the joint of adjacent aesthetic curve segments with respect to the curve lengths become equal to or smaller than a predetermined threshold (preferably, the two derivative values become equal) (step S17). This guarantees the G³ continuity between the aesthetic curve segments. Finally, the display unit 16 displays the shaped line figure (a line figure that includes an aesthetic curve) (step S18, an outputting step).

Next, with reference to FIG. 15, the process where control point data representing a line figure is input will be described. In this case, the receiving unit 11 receives control point data (step S21, a receiving step). The receiving unit 11 further receives the slope α of the straight line in the logarithmic distribution diagram of curvature (step S22). The dividing unit sets segments based on the control point data (step S23, a dividing step). Subsequent processing in steps S24 to S27 is similar to the processing in steps S15 to S18 in FIG. 14.

Thus, as described above, according to this embodiment, the curvature that directly affects the impression of a curve is directly used to shape each segment, and the line figure is shaped to make curvatures at each joint between segments continuous. This allows easily forming a curve preferable for design.

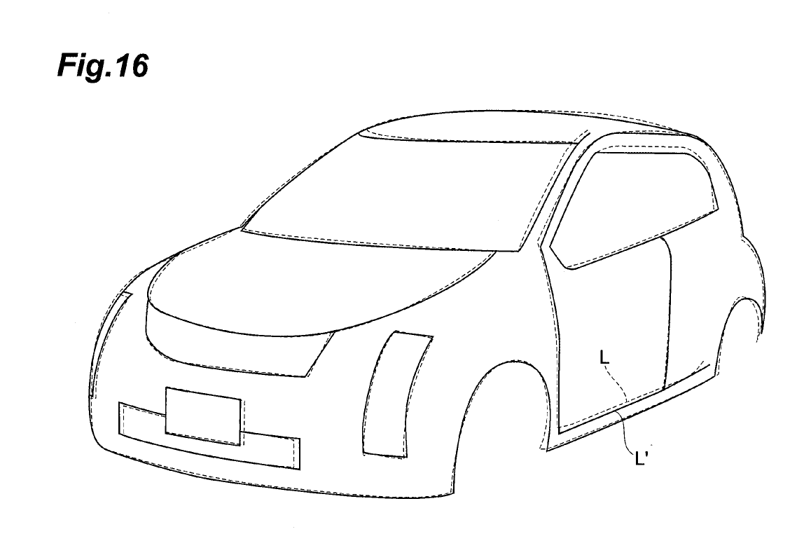

Conventionally, modification of complicated design, for example a car body as shown in FIG. 16, has been made by an operator directly editing a line figure and therefore has involved much effort and time. In contrast, in this embodiment, the CAD system 1 automatically removes influences of shakes of a hand in an input hand-drawn line figure (see a dashed line L) and shapes the line figure (see a solid line L′). Therefore, the design can be modified in a very short time. Such formation or modification of a line figure is applicable not only to car design but also to design of various products and graphic design.

In this embodiment, in addition to the continuity of curvatures between segments, the continuity of derivative values of the curvatures with respect to curve lengths is taken into account to shape each segment. This allows forming a curve more preferable for design.

In this embodiment, the segment information is converted based on the information affecting how the curve bends (the coordinates of an endpoint of each segment, the tangent direction at the endpoint, and the constant α). This allows forming a curve preferable for design.

In this embodiment, the G² continuity is guaranteed by changing the tangent direction at an endpoint of each segment while keeping the position of the endpoint fixed. This allows forming a curve preferable for design without significantly changing the impression of the line figure.

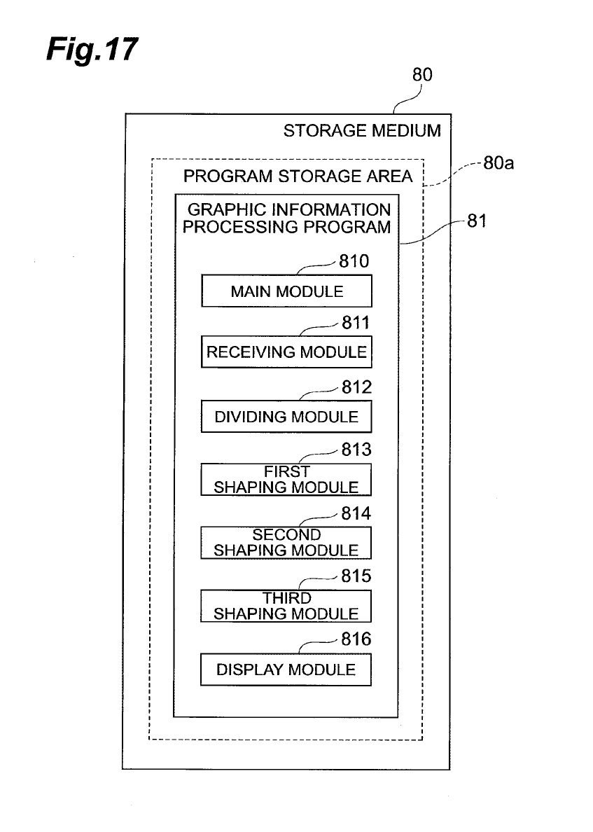

Now, description will be made of a graphic information processing program for causing a computer to perform the above-described sequential graphic information processing. As shown in FIG. 17, a graphic information processing program 81 is stored in a program storage area 80a provided in a recording medium 80 in a computer.

The graphic information processing program 81 includes a main module 810 that centrally controls the above-described sequential graphic information processing, a receiving module 811, a dividing module 812, a first shaping module 813, a second shaping module 814, a third shaping module 815, and a display module 816. Functions implemented by executing the receiving module 811, the dividing module 812, the first shaping module 813, the second shaping module 814, the third shaping module 815, and the display module 816 are similar to the above-described functions of the receiving unit 11, the dividing unit 12, the first shaping unit 13, the second shaping unit 14, the third shaping unit 15, and the display unit 16 of the CAD system 1, respectively.

Part or all of the graphic information processing program 81 may be configured to be transmitted via a transmission medium such as a communication line and received and recorded (installed) by other devices.

Thus, the present invention has been described based on its embodiment. However, the present invention is not limited to the above embodiment. The present invention allows various modifications as follows without departing from its spirit.

In the above embodiment, the display unit 16 outputs the line figure with the G³ continuity guaranteed. However, the display unit 16 may output the graphic information output from the second shaping unit 14 to thereby output a line figure with only the G² continuity guaranteed.

In the above embodiment, the first shaping unit 13 forms the aesthetic curve represented by the above equations (4) and (5). However, the first shaping unit 13 may form an aesthetic curve represented by other equations. A theory of forming an aesthetic curve based on characteristics of a generalized Cornu spiral (GCS) will be described below.

The radius of curvature ρ(s) of a GCS with a curve length of s is represented by the following equation (11):

$$\begin{matrix}[ Expression 18 ] & \\ ρ ( s ) = \frac{S + rs}{p + qs} & ( 11 )\end{matrix}$$

where p, q, r, and S are constants, p, q, r>−1, and S>0. The equation (11) is an equation for a logarithmic spiral if q=0, and an equation for a clothoid curve if r=0.

If e=r/q, and f=S−pr/q, the above equation (11) is modified as follows.

$$ρ ( s ) = e + \frac{f}{p + qs} \qquad [ Expression 19 ]$$

Therefore, the following equation (12) holds:

[Expression 20]

(ρ(s)−e)⁻¹=cs+d (12)

where c=q/f, and d=p/f. Therefore, ρ(s) shifted by a predetermined amount e is given by a linear expression of the curve length s. If the constant α is introduced into the equation (12), the following equation (13) holds.

$$\begin{matrix}[ Expression 21 ] & \\ {( ρ ( s ) - e )}^{α} = cs + d \\ ρ = {( cs + d )}^{\frac{1}{α}} + e & ( 13 )\end{matrix}$$

From the above equation (13), it can be seen that the parameter e is the amount of shifting of the radius of curvature ρ and that the powers of the radius of curvature shifted by a certain amount are represented by a linear function of the curve length.

Similar expansion is also possible for the curvature κ(s), which is the inverse of the radius of curvature ρ, and the following equation (14) holds.

$$\begin{matrix}[ Expression 22 ] & \\ {( κ ( s ) - e )}^{- α} = cs + d \\ κ = {( cs + d )}^{\frac{1}{α}} + e & ( 14 )\end{matrix}$$

The first shaping means may receive inputs of the parameters e, c, and d and form an aesthetic curve represented by the above equation (13) or (14). Here, from the above equation (14), the directional angle θ(s) is represented by the following equation, where it is assumed that α·0, 1.

$$θ ( s ) = {θ}_{0} + {\int }_{0}^{S} \{ {( cu + d )}^{- \frac{1}{α}} + e \} d u \qquad [ Expression 23 ]$$

This equation can be analytically integrated and can be modified as follows.

$$θ ( s ) = {θ}_{0} + \frac{α}{( 1 - α ) c} {( cs + d )}^{\frac{1 - α}{α}} + es \qquad [ Expression 24 ]$$

Thus, the directional angle θ(s) does not need to be determined by numerical integration, and this is advantageous from the viewpoint of the processing speed.

### REFERENCE SIGNS LIST

1 . . . CAD system (graphic information processing device for forming aesthetic curves), 11 . . . receiving unit (receiving means), 12 . . . dividing unit (dividing means), 13 . . . first shaping unit (first shaping means), 14 . . . second shaping unit (second shaping means), 15 . . . third shaping unit (third shaping means), 16 . . . display unit (outputting means), 81 . . . graphic information processing program, 810 . . . main module, 811 . . . receiving module, 812 . . . dividing module, 813 . . . first shaping module, 814 . . . second shaping module, 815 . . . third shaping module, 816 . . . display module

1. A graphic information processing device for forming aesthetic curves, comprising:
a receiving unit for receiving input of graphic information representing a line figure that includes a curve;
a dividing unit for dividing the line figure into a plurality of segments and generating a plurality of pieces of segment information corresponding to the plurality of segments;
a first shaping unit for converting the plurality of pieces of segment information to generate an aesthetic curve by shaping a curve in each of the plurality of segments so that powers of a radius of curvature or a curvature of each segment are represented by a linear function of a curve length of the segment;
a second shaping unit for shaping the plurality of segments by converting the plurality of pieces of segment information converted by the first shaping unit so that a difference between a curvature at an endpoint of one segment and a curvature at an endpoint of another segment connected to the endpoint of the one segment becomes equal to or smaller than a predetermined threshold; and
an outputting unit for outputting the graphic information about the line figure that consists of the plurality of segments shaped by the second shaping unit.

2. The graphic information processing device for forming aesthetic curves according to claim 1, further comprising
a third shaping unit for shaping the plurality of segments by converting the plurality of pieces of segment information converted by the second shaping unit so that a difference between a derivative value of a curvature at an endpoint of one segment with respect to a curve length of the one segment and a derivative value of a curvature at an endpoint of another segment connected to the endpoint of the one segment with respect to a curve length of the another segment becomes equal to or smaller than a predetermined threshold, wherein
the outputting unit outputs the graphic information about the line figure that consists of the plurality of segments shaped by the third shaping unit.

3. The graphic information processing device for forming aesthetic curves according to claim 1, wherein
the second shaping unit converts each of the plurality of pieces of segment information based on coordinates of an endpoint, a tangent direction at the endpoint, and a constant indicating a degree of bending of the curve in the segment in each of the plurality of segments.

4. The graphic information processing device for forming aesthetic curves according to claim 3, wherein
the second shaping unit converts the plurality of pieces of segment information so that the tangent direction at the endpoint of each of the plurality of segments is changed while a position of the endpoint remains fixed.

5. The graphic information processing device for forming aesthetic curves according to claim 1, wherein
the receiving unit receives input of point sequence data representing the line figure.

6. The graphic information processing device for forming aesthetic curves according to claim 1, wherein
the dividing unit divides the line figure at an inflection point of the line figure.

7. The graphic information processing device for forming aesthetic curves according to any one of claims 1 to 6, wherein
the first shaping unit shapes the curve so that powers of the radius of curvature or the curvature shifted by a predetermined amount are represented by a linear function of the curve length.

8. A graphic information processing device for forming aesthetic curves, comprising:
a receiving unit for receiving input of graphic information representing a line figure that includes a curve;
a dividing unit for dividing the line figure into a plurality of segments and generating a plurality of pieces of segment information corresponding to the plurality of segments;
a first shaping unit for generating an aesthetic curve by shaping each segment based on a curvature of the segment;
a second shaping unit for shaping each segment shaped by the first shaping unit based on a curvature at an endpoint of the segment; and
an outputting unit for outputting the graphic information about the line figure that consists of the plurality of segments shaped by the second shaping unit.

9. A graphic information processing method for forming aesthetic curves, comprising:
a receiving step of a graphic information processing device receiving input of graphic information representing a line figure that includes a curve;
a dividing step of the graphic information processing device dividing the line figure into a plurality of segments and generating a plurality of pieces of segment information corresponding to the plurality of segments;
a first shaping step of the graphic information processing device converting the plurality of pieces of segment information to generate an aesthetic curve by shaping a curve in each of the plurality of segments so that powers of a radius of curvature or a curvature of each segment are represented by a linear function of a curve length of the segment;
a second shaping step of the graphic information processing device shaping the plurality of segments shaped in the first shaping step by converting the plurality of pieces of segment information converted in the first shaping step so that a difference between a curvature at an endpoint of one segment and a curvature at an endpoint of another segment connected to the endpoint of the one segment becomes equal to or smaller than a predetermined threshold; and
an outputting step of the graphic information processing device outputting the graphic information about the line figure that consists of the plurality of segments shaped in the second shaping step.

10. A graphic information processing program for forming aesthetic curves, the program causing a computer to perform:
a receiving function for receiving input of graphic information representing a line figure that includes a curve;
a dividing function for dividing the line figure into a plurality of segments and generating a plurality of pieces of segment information corresponding to the plurality of segments;
a first shaping function for converting the plurality of pieces of segment information to generate an aesthetic curve by shaping a curve in each of the plurality of segments so that powers of a radius of curvature or a curvature of each segment are represented by a linear function of a curve length of the segment;
a second shaping function for shaping the plurality of segments by converting the plurality of pieces of segment information converted by the first shaping function so that a difference between a curvature at an endpoint of one segment and a curvature at an endpoint of another segment connected to the endpoint of the one segment becomes equal to or smaller than a predetermined threshold; and
an outputting function for outputting the graphic information about the line figure that consists of the plurality of segments shaped by the second shaping function.
